(19) United States
(12) Patent Application Publication
(10) Pub. No.: US 2026/0246885 A1
(43) Pub. Date: Aug. 20, 2026

(54) INFORMATION PROCESSING DEVICE, PRINT METHOD, AND COMPUTER-READABLE MEDIUM

(71) Applicant: Yukiya Nagase, Susono Shizuoka (JP)

(72) Inventor: Yukiya Nagase, Susono Shizuoka (JP)

(73) Assignee: ETRIA Co., Ltd., Kanagawa (JP)

(21) Appl. No.: 19/452,260

(22) Filed: Jan. 17, 2026

(30) Foreign Application Priority Data
Feb. 18, 2025 (JP) 2025-023933

(51) Int. Cl. H04N 1/387; H04N 1/32

(52) U.S. Cl. CPC H04N 1/3872; H04N 1/32309; H04N 2201/3271

(57) ABSTRACT

An information processing device includes a read requester, a detector, a generator, and an adjustor. The read requester is configured to cause a sensor to read a paper on which one or more marks are drawn. The detector is configured to detect each of the marks from a scan image read by the sensor. The generator is configured to generate a print image in which an object image corresponding to each of the marks, which are detected by the detector, is placed at a position of the respective mark. The adjustor is configured to adjust placement of the object images included in the print image. The print requester is configured to cause a printer to print the print image.

### CROSS-REFERENCE TO RELATED APPLICATIONS

The present application claims priority under 35 U.S.C. § 119 to Japanese Patent Application No. 2025-023933, filed on Feb. 18, 2025. The contents of which are incorporated herein by reference in their entirety.

### BACKGROUND

### Technical Field

Embodiments described herein relate to an information processing device, a print method, and a computer-readable medium.

### Related Art

In related technology, there are known printers for printing a variety of labels. In a print image that is printed by such a printer, the position of a barcode or the position of characters is set based on a numerical value using a dedicated application.

However, since the position of a barcode or the position of characters is set based on a numerical value thereof, there are times when the printer prints an object, such as a barcode or characters, at a different position than the position envisioned by the operator. For that reason, it becomes necessary for the operator to correct the print image after the actual printing has been performed.

### BRIEF DESCRIPTION OF THE DRAWINGS

FIG. 1 is a diagram illustrating an exemplary configuration of a printer system according to an embodiment;

FIG. 2 is a diagram illustrating an exemplary hardware configuration of various devices installed in the printer system according to the embodiment;

FIG. 3 is a block diagram illustrating an exemplary functional configuration of the various devices installed in the printer system according to the embodiment;

FIG. 4 is a diagram illustrating an example of a scan image;

FIG. 5 is a diagram illustrating an example of an editing image;

FIG. 6 is diagram illustrating an example of a notification image;

FIG. 7 is a diagram illustrating an example of a printing condition image;

FIG. 8 is a flowchart for explaining an example of a produced-image printing operation performed by an information processing device according to the embodiment; and

FIG. 9 is a flowchart for explaining an example of a reading operation performed by the information processing device according to the embodiment.

### DETAILED DESCRIPTION

An information processing device according to an embodiment includes a read requester, a detector, a generator, and an adjustor. The read requester is configured to cause a sensor to read a paper on which one or more marks are drawn. The detector is configured to detect each of the marks from a scan image read by the sensor. The generator is configured to generate a print image in which an object image corresponding to each of the marks, which are detected by the detector, is placed at a position of the respective mark. The adjustor is configured to adjust placement of the object images included in the print image. The print requester is configured to cause a printer to print the print image.

An embodiment may provide an information processing device, a print method, and a computer-readable medium that enable the operator to intuitively understand the placement of objects to be printed by a printer.

An embodiment of an information processing device and a computer program product is described below in detail with reference to the accompanying drawings. However, the embodiment described below is only an exemplary embodiment of the information processing device and the computer program product, and the configuration and the specifications are not limited by the embodiment.

### Embodiment

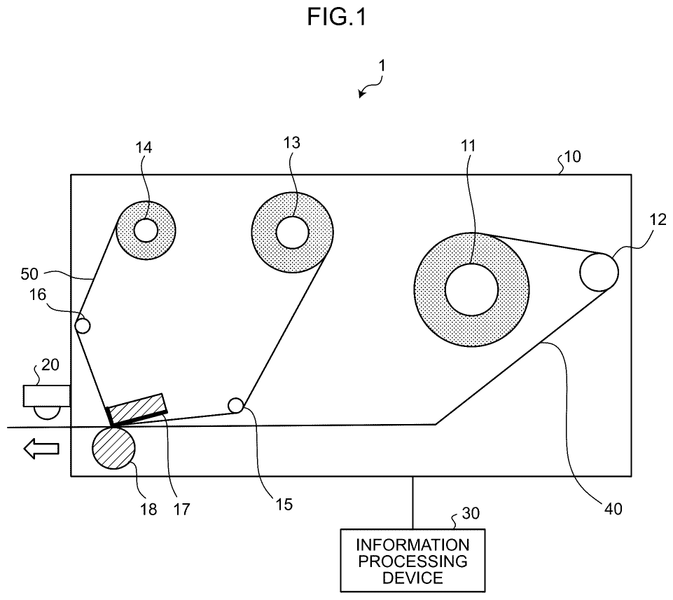

FIG. 1 is a diagram illustrating an exemplary configuration of a printer system 1 according to the embodiment. A printer system 1 includes a printer 10, a contact image sensor (CIS) 20, and an information processing device 30.

The printer 10 prints a variety of information on a roll paper 40 that is rolled up. For example, under the control performed by the information processing device 30, the printer 10 prints a print image onto a label.

The CIS 20 is a sensor for reading the roll paper 40 that has been discharged from the printer 10. The CIS 20 is installed at the discharge port from which the printer 10 discharges the roll paper 40. Then, the CIS 20 reads the roll paper 40 that has been discharged from the printer 10. For example, the CIS 20 reads the roll paper 40 on which a mark is formed as a result of pressing of a stamp. For example, in the case of using a black ink stamp, when that stamp is pressed, a black region is formed as the mark on the roll paper 40.

The information processing device 30 is a device such as a personal computer or a server. The information processing device 30 causes the printer 10 to print a print image.

The printer 10 includes a roll paper holding unit 11, a damper mechanism 12, an ink ribbon holding unit 13, an ink ribbon winding unit 14, a first shaft 15, a second shaft 16, a print head 17, and a platen roller 18.

The roll paper holding unit 11 holds the roll paper 40, which is rolled up, in a rotatable manner. For example, in the roll paper holding unit 11, the roll paper 40 on which a mark is drawn is installed. The roll paper holding unit 11 represents an example of a paper holding unit (paper holder). More specifically, as a result of being rotatably held in the roll paper holding unit 11, the roll paper 40 is drawn out accompanying the rotation of the platen roller 18. The roll paper 40 may be a label without a label mount or a label with a label mount. Further, the roll paper 40 is not limited to labels, and may be a receipt paper or some other paper.

The damper mechanism 12 is disposed in between the roll paper holding unit 11 and the platen roller 18; and applies, onto the roll paper 40, a pressure corresponding to the tension exerted on the roll paper 40. As a result, the damper mechanism 12 keeps the tension exerted on the roll paper 40 within a specified range. Herein, at the time of starting the feeding of the roll paper 40, a relatively higher tension is exerted on the roll paper 40. In that case, sometimes the print head 17 and the platen roller 18 are not able to perform normal printing on the roll paper 40. In that regard, according to the tension exerted in the roll paper 40, the damper mechanism 12 applies a pressure onto the roll paper 40.

The ink ribbon holding unit 13 holds an ink ribbon 50, which is rolled up, in a rotatable manner. As a result of being rotatably held by the ink ribbon holding unit 13, the ink ribbon 50 is drawn out accompanying the rotation of the ink ribbon winding unit 14.

The ink ribbon winding unit 14 winds the ink ribbon 50. For example, the ink ribbon winding unit 14 includes a motor. Thus, due to the rotation of the motor, the ink ribbon winding unit 14 winds the ink ribbon 50.

The first shaft 15 is disposed in between the ink ribbon holding unit 13 and the print head 17, and guides the ink ribbon 50. The first shaft 15 rotates in accordance with the conveyance of the ink ribbon 50.

The second shaft 16 is disposed in between the print head 17 and the ink ribbon winding unit 14, and guides the ink ribbon 50. The second shaft 16 rotates in accordance with the conveyance of the ink ribbon 50.

The print head 17 performs printing on the roll paper 40. For example, the print head 17 is a thermal head in which a plurality of heating elements is lined up. The print head 17 heats the heating elements that correspond to a print image, and performs printing on the roll paper 40 that is sandwiched between the platen roller 18 and the print head 17.

The platen roller 18 rotates so as to feed the roll paper 40 that was being held by the roll paper holding unit 11. The platen roller 18 represents an example of a roller. For example, the platen roller 18 includes a motor. Thus, due to the rotation of the motor, the platen roller 18 feeds the roll paper 40 that is sandwiched between the platen roller 18 and the print head 17. In other words, the platen roller 18 draws out the roll paper 40 from the roll paper holding unit 11. Then, the printer 10 discharges the roll paper 40 from the discharge port meant for discharging the roll paper 40 that has been fed by the platen roller 18.

The CIS 20 reads the roll paper 40 that has been discharged from the discharge port of the printer 10.

Given below is the explanation of a hardware configuration of various devices installed in the printer system 1.

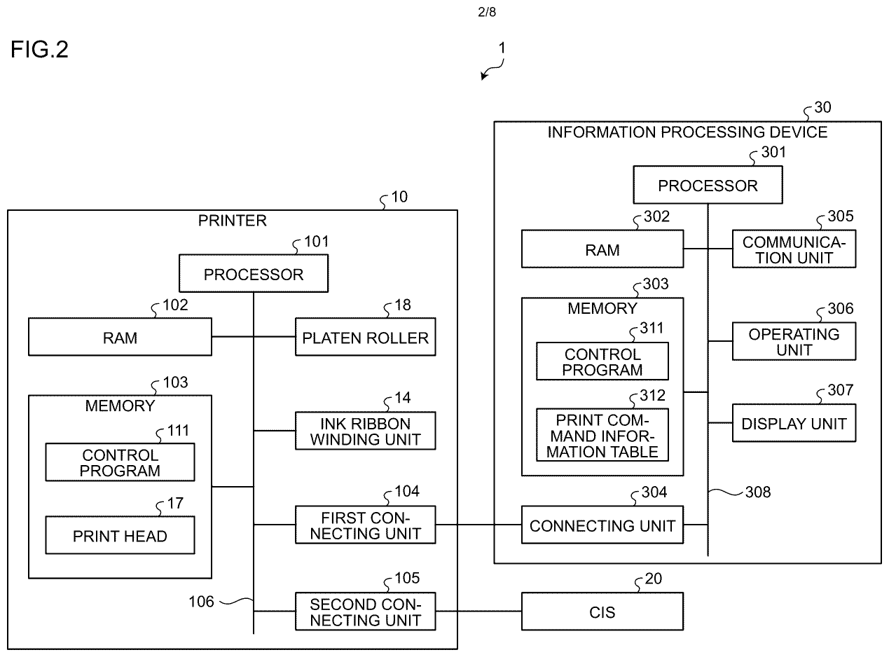

FIG. 2 is a diagram illustrating an exemplary hardware configuration of the various devices installed in the printer system 1 according to the embodiment.

The printer 10 includes a processor 101, a random access memory (RAM) 102, a memory 103, the print head 17, the platen roller 18, the ink ribbon winding unit 14, a first connecting unit 104, and a second connecting unit 105. Those constituent elements are connected to each other via an internal bus 106.

The processor 101 is a processing circuit such as a central processing unit (CPU) that controls the operations of the printer 10. The RAM 102 is a memory medium in which various computer programs and a variety of data are temporarily stored. The processor 101 executes a control program 111, which is stored in the memory 103, while using the RAM 102 as the work area.

The memory 103 is an auxiliary storage device such as a hard disk drive (HDD), or a solid state drive (SSD), or a flash memory. For example, the memory 103 stores therein the control program 111. For example, the memory 103 represents an example of a memory medium that is a non-transitory computer-readable medium in which the commands to be executed by a computer are stored.

The control program 111 is a computer program meant for implementing the functions of the printer 10. The control program 111 includes computer programs meant for implementing characteristic functions according to the embodiment. Moreover, the control program 111 includes an application meant for generating a print command from image data and an application meant for editing the image data.

The first connecting unit 104 is an interface for establishing connection with the information processing device 30. For example, the first connecting unit 104 is an interface such as a universal serial bus (USB) or a serial port. Alternatively, the first connecting unit 104 may be an interface such as Bluetooth (registered trademark) that establishes connection using wireless communication.

The second connecting unit 105 is an interface for establishing connection with the CIS 20. For example, the second connecting unit 105 is an interface such as a USB or a serial port. Alternatively, the second connecting unit 105 may be an interface such as Bluetooth (registered trademark) that establishes connection using wireless communication.

The information processing device 30 includes a processor 301, a RAM 302, a memory 303, a connecting unit 304, a communication unit 305, an operating unit 306, and a display unit (display) 307. Those constituent elements are connected to each other via an internal bus 308.

The processor 301 is a processing circuit such as a CPU that controls the operations of the information processing device 30. The RAM 302 is a memory medium in which various computer programs and a variety of data are temporarily stored. The processor 301 executes a control program 311, which is stored in the memory 303, while using the RAM 302 as the work area. Those constituent elements are connected to each other via an internal bus 308.

The memory 303 is an auxiliary storage device such as an HDD, or an SSD, or a flash memory. For example, the memory 303 stores therein the control program 311 and a print command information table 312.

The control program 311 is a computer program meant for implementing the functions of the information processing device 30. The control program 311 includes computer programs meant for implementing characteristic functions according to the embodiment. For example, the memory 303 represents an example of a memory medium that is a non-transitory computer-readable medium in which the commands to be executed by a computer are stored.

The print command information table 312 is an information table including one or more print commands. A print command represents the information indicating the print content that is to be printed by the printer 10.

The connecting unit 304 is an interface for establishing connection with the printer 10. For example, the connecting unit 304 is an interface such as a USB or a serial port. Alternatively, the connecting unit 304 may be an interface such as Bluetooth (registered trademark) that establishes connection using wireless communication.

The communication unit 305 is a wired communication device such as a network interface card. For example, the communication unit 305 performs communication with external device via a LAN cable (not illustrated) (LAN stands for Local Area Network).

The operating unit 306 is an input device such as a keyboard or a mouse meant for inputting various operations.

The display unit 307 is a display such as a liquid crystal display or an organic electro luminescence (EL) display.

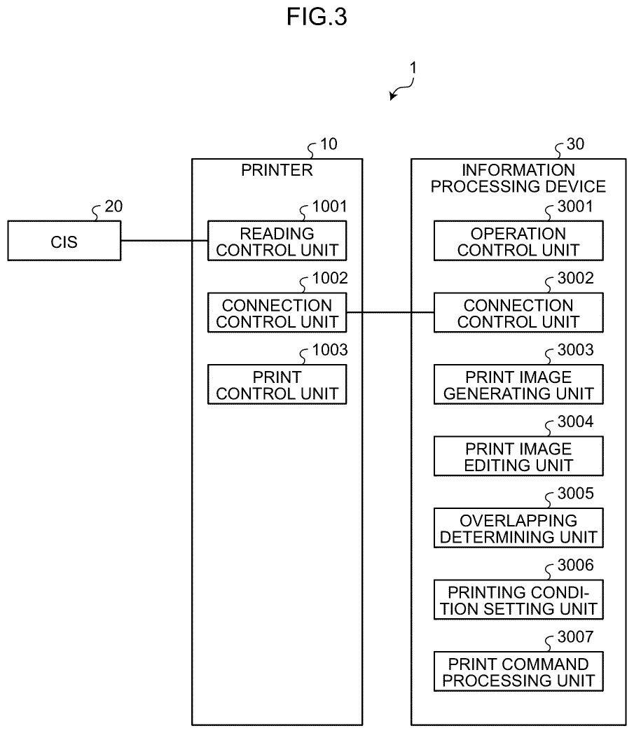

Given below is the explanation of the functions of the various devices installed in the printer system 1. FIG. 3 is a block diagram illustrating an exemplary functional configuration of the various devices installed in the printer system 1 according to the embodiment.

The processor 101 included in the printer 10 expands the control program 111, which is stored in the memory 103, in the RAM 102 and performs operations according to the control program 111, and generates various function units in the RAM 102. As a result, the processor 101 of the printer 10 includes a reading control unit 1001, a connection control unit 1002, and a print control unit 1003 as the function units.

The reading control unit 1001 determines whether or not the CIS 20 is connected. When the CIS 20 reads the roll paper 40 that is held by the roll paper holding unit 11 and on which a stamp is pressed, the information processing device 30 generates a print command. Thus, in the case of obtaining a print command, the reading control unit 1001 determines whether or not the CIS 20 is connected.

When the CIS 20 is connected, the reading control unit 1001 obtains a scan image G1 read by the CIS 20. More specifically, when the CIS 20 is connected and when a read request is received from the information processing device 30, the reading control unit 1001 obtains the scan image G1 that was read by the CIS 20.

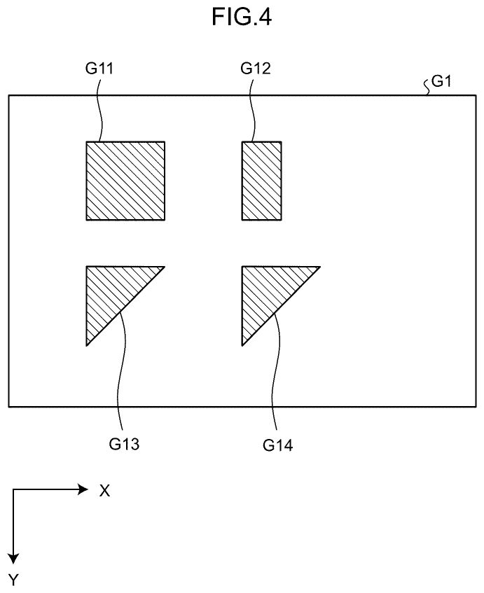

FIG. 4 is a diagram illustrating an example of the scan image G1. As illustrated in FIG. 4, the scan image G1 is an image generated by scanning the roll paper 40 on which one or more marks are formed. For that reason, in the scan image G1, scan regions are included in which the marks formed on the roll paper 40 by pressing stamps are turned into images. For example, the scan image G1 illustrated in FIG. 4 includes a first stamp region G11 formed in a square shape, a second stamp region G12 formed in a rectangular shape, a third stamp region G13 formed in a triangular shape, and a fourth stamp region G14 formed in a triangular shape.

The connection control unit 1002 controls the first connecting unit 104 and enables communication with the information processing device 30. For example, the connection control unit 1002 sends the scan image G1, which is obtained by the reading control unit 1001, to the information processing device 30. For example, the connection control unit 1002 receives a print command from the information processing device 30.

The print control unit 1003 performs printing on the roll paper 40 based on the print command received by the connection control unit 1002.

The processor 301 included in the information processing device 30 expands the control program 311, which is stored in the memory 303, into the RAM 302 and performs operations according to the control program 311, and generates various function units in the RAM 302. As a result, the processor 301 of the information processing device 30 includes an operation control unit 3001, a connection control unit 3002, a print image generating unit 3003, a print image editing unit 3004, an overlapping determining unit 3005, a printing condition setting unit (printing condition setter) 3006, and a print command processing unit 3007 as the function units.

The operation control unit 3001 controls the operating unit 306 and receives various operations. For example, the operation control unit 3001 receives an operation that requests reading of the roll paper 40 on which one or more marks are drawn as a result of pressing of stamps.

The connection control unit 3002 controls the connecting unit 304 and enables communication with the printer 10. For example, when an operation that requests reading of the roll paper 40 is received by the operation control unit 3001, the connection control unit 3002 sends a read request to the information processing device 30 as a request to cause the sensor to read the roll paper 40 on which one or more marks are drawn. The connection control unit 3002 represents an example of a read requesting unit (read requester). That is, the connection control unit 3002 sends a read request to the information processing device 30 as a request to cause the CIS 20, which is installed in the printer 10, to read the roll paper 40.

For example, in response to the read request, the connection control unit 3002 receives the scan image G1 from the printer 10.

For example, the connection control unit 3002 sends a print command to the information processing device 30 as a command to cause the printer 10 to print a print image. The connection control unit 3002 represents an example of a print requesting unit (print requester).

Based on the scan image G1 obtained by the connection control unit 3002, the print image generating unit 3003 generates a print image that is to be printed by the printer 10. The print image generating unit 3003 generates a print image in which object images corresponding to the types of stamp regions included in the scan image G1 are placed at the positions corresponding to the positions of the stamp regions. Thus, the print image generating unit 3003 generates a print image in which the object images corresponding to the marks formed on the roll paper 40 are placed at the positions of those marks. The print image generating unit 3003 represents an example of a generating unit (generator). In an object image, for example, a code symbol such as a QR code (registered trademark) or a barcode is included as an object, or a character string is included as an object. However, an object image is not limited to include a code symbol or a character string, and may be another image such as an illustration, a table, or a graph.

The print image generating unit 3003 detects each mark from the scan image G1. The print image generating unit 3003 represents an example of a detecting unit (detector). More specifically, according to the shapes of the stamp regions, the print image generating unit 3003 identifies the types of object images corresponding to the types of the stamp regions. For example, based on the area of a stamp region and the lengths of the stamp region in the specified directions, the print image generating unit 3003 identifies the type of the object image corresponding to the type of that stamp region.

Moreover, the print image generating unit 3003 may detect, from the scan image G1, the stamp region drawn in a predetermined color. For example, when ruled lines are drawn on the roll paper 40, the print image generating unit 3003 can hold down false detection of the stamp regions attributed to the ruled lines.

The print image generating unit 3003 extracts the stamp regions from the scan image G1. For example, the print image generating unit 3003 extracts, as the stamp region, a black region greater than or equal to an arbitrary threshold value such as 40 square millimeters.

Moreover, the print image generating unit 3003 assigns identification numbers to the extracted stamp regions so as to enable identification of the stamp regions. Then, according to the shape of each stamp region, the print image generating unit 3003 identifies the type of the object image corresponding to the type of that stamp region.

For example, in the case of a square stamp region such as the first stamp region G11 illustrated in FIG. 4, the print image generating unit 3003 identifies that a two-dimensional code is present. When the stamp region has a length of 9 mm in the X-axis direction as well as in the Y-axis direction and has an area of 90 square millimeters, the print image generating unit 3003 identifies that the object image corresponding to that stamp region is a two-dimensional code.

Moreover, in the case of a rectangular stamp region such as the second stamp region G12 illustrated in FIG. 4, the print image generating unit 3003 identifies that a one-dimensional code such as a barcode is present. When the stamp region has a length of 9 mm in the Y-axis direction and has an area of 60 square millimeters, the print image generating unit 3003 identifies that the object image corresponding to that stamp region is a one-dimensional code.

Furthermore, in the case of a triangular stamp region such as the third stamp region G13 or the fourth stamp region G14 illustrated in FIG. 4, the print image generating unit 3003 identifies that a one-dimensional code such as a character string is present. When the stamp region has a length of 9 mm in the X-axis direction as well as in the Y-axis direction but does not have an area of 90 square millimeters, the print image generating unit 3003 identifies that the object image corresponding to that stamp region is a character string.

Meanwhile, a stamp region that does not conform with the square shape, the rectangular shape, or the triangular shape, there is a possibility that some portion of the stamp is not transferred. In that regard, according to the sizes of the drawn stamp regions included in the scan image G1, the print image generating unit 3003 displays a re-stamping image in the display unit 307. A re-stamping image is an image for notifying to press a stamp again in the case in which a stamp region does not conform with any specified shape is present as an image in which some portion of the stamp is not transferred.

The print image editing unit 3004 edits the print image generated by the print image generating unit 3003. That is, the print image editing unit 3004 adjusts the placement of the object images included in the print image. The print image editing unit 3004 represents an example of an adjusting unit (adjustor). For example, based on the scan image G1, the print image editing unit 3004 displays an editing image G2 in the display unit 307. Then, in the editing image G2 meant for editing the object images, the print image editing unit 3004 receives the adjustment about the placement of the object images.

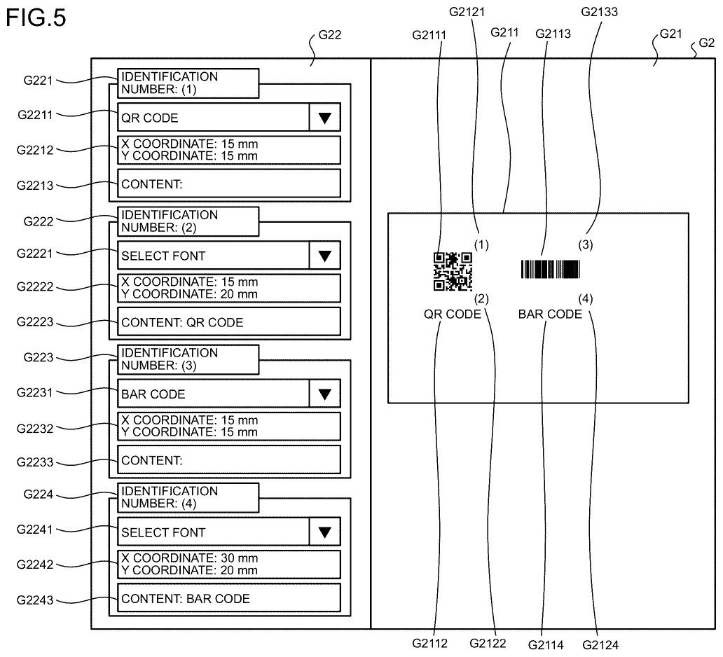

FIG. 5 is a diagram illustrating an example of the editing image G2. The print image editing unit 3004 includes an image display region G21 and an image setting region G22. The image display region G21 is a region in which an editing progress image G211 is displayed. Thus, the editing progress image G211 is an image in which the object images corresponding to the setting performed in the image setting region G22 are placed at the positions according to the setting performed in the image setting region G22. The print image editing unit 3004 displays the print image, which is generated by the print image generating unit 3003, as the editing progress image G211 in the image display region G21. Subsequently, when the setting is changed in the image setting region G22, the print image editing unit 3004 displays the editing progress image G211 according to the changed setting in the image setting region G22.

As illustrated in FIG. 5, the editing progress image G211 includes a first object image G2111, a second object image G2112, a third object image G2113, and a fourth object image G2114. Moreover, in the editing progress image G211, the identification number for enabling identification of each object image is displayed in a corresponding manner to that object image. That is, the editing progress image G211 includes a first identification number G2121 associated to the first object image G2111, a second identification number G2122 associated to the second object image G2112, a third identification number G2123 associated to the first object image G2113, and a fourth identification number G2124 associated to the fourth object image G2114.

The image setting region G22 is an image enabling editing of the setting for each object image included in the editing progress image G211. The editing progress image G211 illustrated in FIG. 5 includes four object images, namely, the first object image G2111, the second object image G2112, the third object image G2113, and the fourth object image G2114. Accordingly, the image setting region G22 includes a first object setting image G221, a second object setting image G222, a third object setting image G223, and a fourth object setting image G224.

The first object setting image G221, the second object setting image G222, the third object setting image G223, and the fourth object setting image G224 are the images meant for inputting the setting regarding the corresponding object images.

The first object setting image G221 includes a first object selection region G2211, a first object placement input region G2212, and a first object content input region G2213.

The first object selection region G2211 is a region for receiving the selection of the subcategory of the type of the object image identified by the print image generating unit 3003. For example, when the object image identified by the print image generating unit 3003 has the type indicating a two-dimensional code, the first object setting image G221 receives the selection of the subcategory such as a QR code (registered trademark) or a data matrix. Moreover, the first object setting image G221 may receive the selection of the orientation of the first object image G2111 that indicates a QR code (registered trademark) or a data matrix.

The first object placement input region G2212 receives the coordinates for the placement of the first object image G2111.

The first object content input region G2213 receives edits for the content indicated by the first object image G2111. For example, when the first object image G2111 is a two-dimensional code, the first object content input region G2213 receives the content indicated by the two-dimensional code. In other words, the first object content input region G2213 receives the content that can be obtained by decoding the two-dimensional code.

The second object setting image G222 includes a second object selection region G2221, a second object placement input region G2222, and a second object content input region G2223.

The second object selection region G2221 is a region for receiving the selection of the subcategory of the type of the object image identified by the print image generating unit 3003. For example, when the object image identified by the print image generating unit 3003 has the type indicating a one-dimensional code, the second object setting image G222 receives the selection of the subcategory such as a JAN code or a UPS code. Moreover, the second object setting image G222 may receive the selection of the orientation of the second object image G2112 that indicates a JAN code or a UPS code.

The second object placement input region G2222 receives the coordinates for the placement of the second object image G2112.

The second object content input region G2223 receives edits for the content indicated by the second object image G2112. For example, when the second object image G2112 is a one-dimensional code, the second object content input region G2223 receives the content indicated by the one-dimensional code. In other words, the second object content input region G2223 receives the content that can be obtained by decoding the one-dimensional code.

The third object setting image G223 includes a third object selection region G2231, a third object placement input region G2232, and a third object content input region G2233.

The third object selection region G2231 is a region for receiving the selection of the subcategory of the type of the object image identified by the print image generating unit 3003. For example, when the object image identified by the print image generating unit 3003 has the type indicating a character string, the third object setting image G223 receives the selection of the subcategory such as the font of the character string, or the color of the character string, or the size of the character string. Moreover, the third object setting image G223 may receive the selection of the orientation of the character string.

The third object placement input region G2232 receives the coordinates for the placement of the third object image G2113.

The third object content input region G2233 receives edits for the content indicated by the third object image G2113. For example, when the third object image G2113 is a character string, the third object content input region G2233 receives the content indicated by the character string. In other words, the third object content input region G2233 receives the text indicated by the character string.

The fourth object setting image G224 includes a fourth object selection region G2241, a fourth object placement input region G2242, and a fourth object content input region G2243.

The fourth object selection region G2241 is a region for receiving the selection of the subcategory of the type of the object image identified by the print image generating unit 3003. For example, when the object image identified by the print image generating unit 3003 has the type indicating a character string, the fourth object setting image G224 receives the selection of the subcategory such as the font of the character string, or the color of the character string, or the size of the character string. Moreover, the fourth object setting image G224 may receive the selection of the orientation of the character string.

The fourth object placement input region G2242 receives the coordinates for the placement of the fourth object image G2114.

The fourth object content input region G2243 receives edits for the content indicated by the fourth object image G2114. For example, when the fourth object image G2114 is a character string, the third object content input region G2243 receives the content indicated by the character string. In other words, the fourth object content input region G2243 receives the text indicated by the character string.

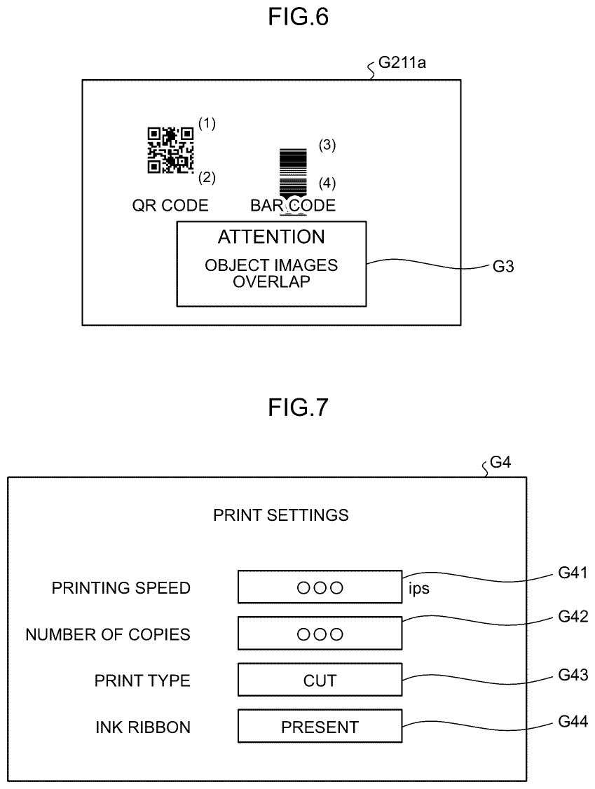

The overlapping determining unit 3005 determines whether or not the object images overlap. When a plurality of object images overlap at least partially, the overlapping determining unit 3005 displays, on the display unit 307, a notification image G3 for notifying about the overlapping of the object images. The overlapping determining unit 3005 represents an example of a notifying unit (notifier). FIG. 6 is diagram illustrating an example of the notification image G3. As illustrated in FIG. 6, the notification image G3 notifies that the object images are overlapping each other.

The printing condition setting unit 3006 receives, in a printing condition image G4, the setting regarding the printing conditions. The printing conditions include the printing speed, the number of copies, the type of the print medium, and the presence or absence of the ink ribbon 50.

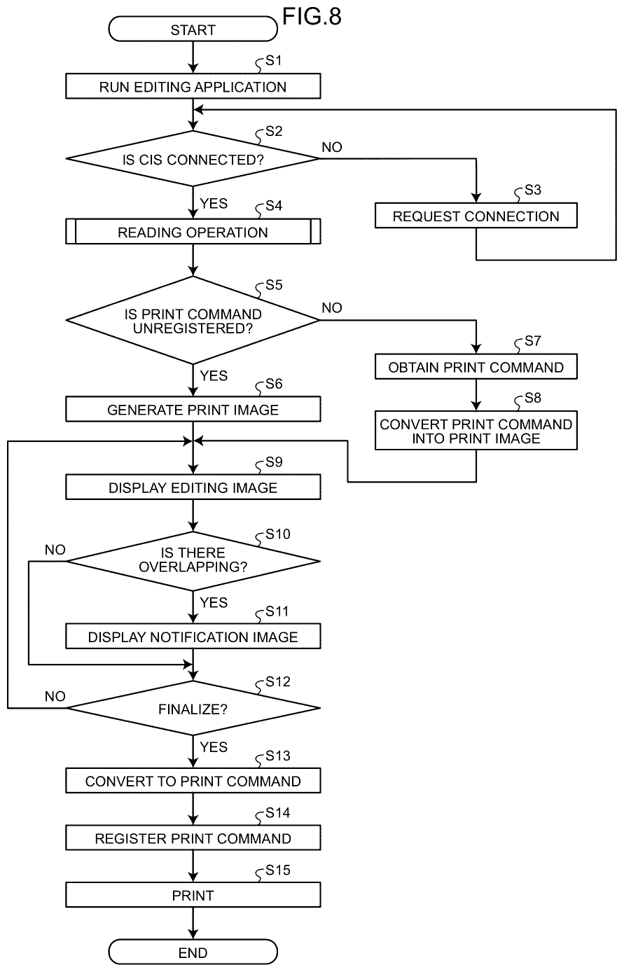

FIG. 7 is a diagram illustrating an example of the printing condition image G4. The printing condition image G4 includes a printing speed setting region G41, a number-of-copies setting region G42, a printing type setting region G43, and an ink ribbon setting region G44. The printing speed setting region G41 is a region for inputting the setting about the printing speed of the printer 10. The number-of-copies setting region G42 is a region for inputting the setting about the number of copies to be printed by the printer 10. The printing type setting region G43 indicates the setting about the type of the roll paper 40. For example, the printing type setting region G43 indicates the setting about the roll paper 40 that gets detached from the label mount or indicates the setting about the roll paper 40 that does not involve a label mount and that gets cut. The ink ribbon setting region G44 is a region for inputting the setting about the presence or absence of the ink ribbon 50.

The print command processing unit 3007 processes a print command. For example, when an operation for requesting printing of a print image is received via the operating unit 306, the print command processing unit 3007 converts the print image into a print command. That is, the print command processing unit 3007 converts the print image, which is generated by the print image generating unit 3003, into a print command; or converts the editing progress image G211, which is obtained by the print image editing unit 3004 by editing the print image, into a print command. Meanwhile, the operation for requesting the printing of a print image is not limited to explicitly performing an operation to request the printing, and may be the operation of completing the editing in the editing image G2 or another operation.

When a print image is converted into a print command, the print command processing unit 3007 registers the print command in the print command information table 312. That is, the print command processing unit 3007 stores a print command, which corresponds to a print image, in the memory 303. The print command processing unit 3007 represents an example of a memory control unit (memory controller).

Moreover, the print command processing unit 3007 causes the connection control unit 3002 to send a print request as a request to perform printing according to the print command. The print request includes the printing conditions set by the printing condition setting unit 3006. That is, the print command processing unit 3007 causes the connection control unit 3002 to send a print request as a request to print the print image according to the printing conditions.

Given below is the explanation about the operations performed by the variety of devices included in the printer system 1.

FIG. 8 is a flowchart for explaining an example of a produced-image printing operation performed by the information processing device 30 according to the embodiment. The produced-image printing operation is performed to print a print image that is produced by the operator.

Before starting the produced-image printing operation, the operator attaches the roll paper 40, on which a stamp is pressed at the beginning, to the roll paper holding unit 11.

The processor 301 runs an editing application that receives edits for the print image (Step S1).

The connection control unit 3002 determines whether or not the CIS 20 is connected to the printer 10 (Step S2).

When the CIS 20 is not connected to the printer 10 (No at Step S2), the connection control unit 3002 notifies that the CIS 20 is not connected (Step S3). Then, the system control returns to Step S2.

When the CIS 20 is connected to the printer 10 (Yes at Step S2), the information processing device 30 performs a reading operation illustrated in FIG. 8 (Step S4). That is, the information processing device 30 performs a reading operation for reading the roll paper 40 on which a stamp is pressed.

The print image generating unit 3003 determines whether or not a print command corresponding to the data read in the reading operation is registered in the print command information table 312 (Step S5).

When a print command identical or similar to the data read in the reading operation is not registered in the print command information table 312 (Yes at Step S5), the print image generating unit 3003 generates a print image based on the data read in the reading operation (Step S6).

When a print command identical or similar to the data read in the reading operation is registered in the print command information table 312 (No at Step S5), the print image generating unit 3003 obtains the corresponding print command from the print command information table 312 (Step S7).

The print image generating unit 3003 converts the print command into a print image (Step S8). That is, in the print command information table 312, when a print command corresponding to a print image having identical or similar placement to the placement of the stamp regions read in the reading operation is registered, the print image generating unit 3003 obtains the print image obtained by converting the print command registered in the print command information table 312. For example, similarity with the placement of the stamp regions implies that the stamp regions are placed within the specified range. In this way, as a result of obtaining the print command from the print command information table 312, the print image generating unit 3003 can obtain the print image adjusted in the past, thereby enabling achieving reduction in the time and efforts required in adjusting the print image.

The print image editing unit 3004 displays, in the display unit 307, the editing image G2 in which the print image is included (Step S9). In the editing image G2, the print image editing unit 3004 receives edits for the print image.

The print image editing unit 3004 determines whether or not overlapping object images are present in the editing image G2 (Step S10). When overlapping object images are not present (No at Step S10), the system control proceeds to Step S12.

When overlapping object images are present (Yes at Step S10), the print image editing unit 3004 displays the notification image G3 as a notification about the overlapping of the object images (Step S11).

The operation control unit 3001 determines whether or not an operation for finalizing the print image is received (Step S12). In other words, the operation control unit 3001 determines whether or not an operation for finalizing the print image and requesting the printing of the print image is received. When an operation for finalizing the print image is not received (No at Step S12), the system control returns to Step S9.

When an operation for finalizing the print image is received (Yes at Step S12), the print command processing unit 3007 converts the print image into a print command (Step S13).

The print command processing unit 3007 registers the print command, which is obtained by conversion, in the print command information table 312 (Step S14).

The print command processing unit 3007 requests the printer 10 to print the print image corresponding to the print command (Step S15). In response, the print control unit 1003 of the printer 10 prints the print image, which corresponds to the print command, on the roll paper 40.

With that, the information processing device 30 ends the produced-image printing operation.

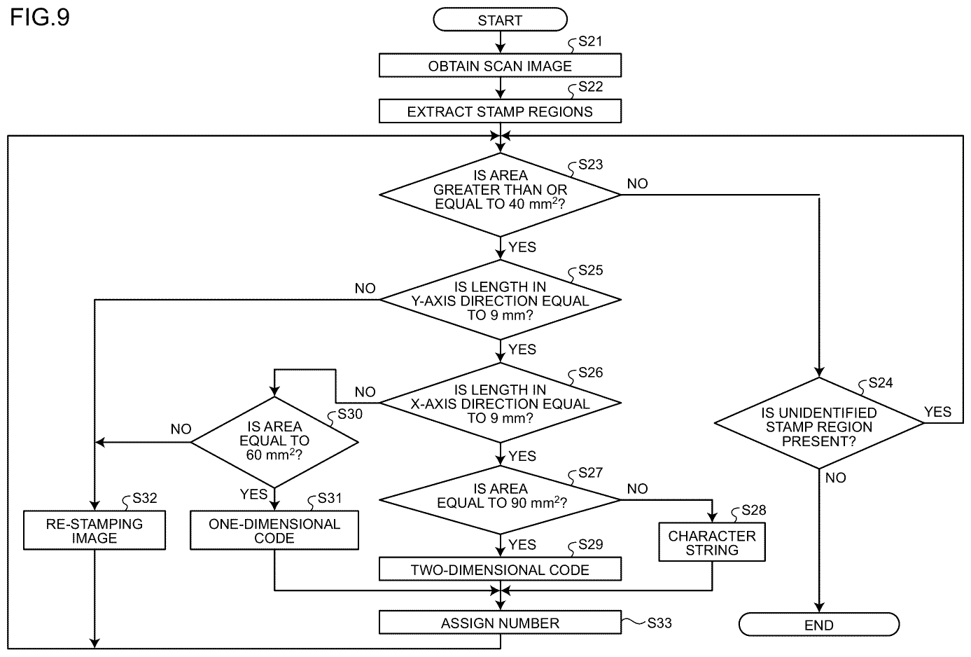

FIG. 9 is a flowchart for explaining an example of the reading operation performed by the information processing device 30 according to the embodiment. The reading operation represents the operation performed at Step S4 illustrated in FIG. 8.

The connection control unit 3002 obtains the scan image G1, which is read from the CIS 20, from the printer 10 (Step S21).

The print image generating unit 3003 extracts one or more stamp regions from the scan image G1 (Step S22).

The print image generating unit 3003 determines whether or not the target stamp region to be identified, which is selected from one or more extracted stamp regions, has an area greater than or equal to 40 square millimeters (Step S23).

When the stamp region has an area smaller than 40 square millimeters (No at Step S23), the print image generating unit 3003 determines whether or not any unidentified stamp region is present (Step S24). When an unidentified stamp region is present (Yes at Step S24), the system control returns to Step S23.

When the stamp region has an area greater than or equal to 40 square millimeters (Yes at Step S23), the print image generating unit 3003 determines whether or not the target stamp region to be identified has a length of 9 millimeters in the Y-axis direction (Step S25).

When the target stamp region to be identified has a length of 9 millimeters in the Y-axis direction (Yes at Step S25), the print image generating unit 3003 determines whether or not the target stamp region to be identified has a length of 9 millimeters in the X-axis direction (Step S26).

When the target stamp region to be identified has a length of 9 millimeters in the X-axis direction (Yes at Step S26), the print image generating unit 3003 determines whether or not the target stamp region to be identified has an area of 90 square millimeters (Step S27).

When the area of the target stamp region to be identified is not equal to 90 square millimeters (No at Step S27), the print image generating unit 3003 determines that the object image corresponding to the target stamp region to be identified is a character string (Step S28). In other words, the print image generating unit 3003 determines that the target stamp region to be identified is a triangular region. Then, the system control proceeds to Step S33.

When the target stamp region to be identified has an area of 90 square millimeters (Yes at Step S27), the print image generating unit 3003 determines that the object image corresponding to the target stamp region to be identified is a two-dimensional code (Step S29). In other words, the print image generating unit 3003 determines that the target stamp region to be identified is a square region. Then, the system control proceeds to Step S33.

When the target stamp region to be identified does not have a length of 9 millimeters in the X-axis direction (Yes at Step S26), the print image generating unit 3003 determines whether or not the target stamp region to be identified has an area greater than or equal to 60 square millimeters (Step S30).

When the target stamp region to be identified has an area greater than or equal to 60 square millimeters (Yes at Step S30), the print image generating unit 3003 determines that the object image corresponding to the target stamp region to be identified is a one-dimensional code (Step S31). In other words, the print image generating unit 3003 determines that the target stamp region to be identified is a rectangular region. Then, the system control proceeds to Step S33.

When the target stamp region to be identified has an area smaller than 60 square millimeters (No at Step S30), the system control proceeds to Step S32.

The print image generating unit 3003 assigns an identification number to each object image (Step S33). Then, the system control proceeds to Step S23.

When the target stamp region to be identified does not have a length of 9 millimeters in the Y-axis direction (No at Step S25), the print image generating unit 3003 displays a re-stamping image in the display unit 307 as an image for notifying to pressing a stamp again (Step S32). Since there is no match for the specified form and since the stamp regions cannot be identified, the print image generating unit 3003 displays a re-stamping image in the display unit 307 as an image for notifying about again performing stamping. That is, the print image generating unit 3003 displays a re-stamping image for the stamp region having the size that does not conform from among the image regions having an area greater than or equal to a first threshold value such as 40 square millimeters explained at Step S23. For example, when the lengths of a stamp region in the X-axis direction and the Y-axis direction are not equal to the corresponding specified values such as 9 millimeters set for each direction, the print image generating unit 3003 displays a re-stamping image. Then, the system control returns to Step S23.

At Step S24, when an unidentified stamp region is not present (No at Step S24), the information processing device 30 ends the reading operation.

As explained above, the information processing device 30 according to the present embodiment causes the CIS 20, which is installed in the printer 10, to read the roll paper 40 on which stamps are pressed. Moreover, the information processing device 30 detects marks from the scan image read by the CIS 20. Furthermore, the information processing device 30 generates a print image in which the object images corresponding to the detected marks are placed at the positions of those marks. Moreover, in the editing image G2, the information processing device 30 receives adjustment about the placement of the object images. Then, the information processing device 30 causes the printer 10 to print the print image.

In this way, the information processing device 30 causes the CIS 20 to read the roll paper 40 on which marks are drawn by pressing stamps. Then, the information processing device 30 receives adjustment in the print image based on the data read by the CIS 20. That is, the information processing device 30 generates a print image without using a dedicated application. Thus, the information processing device 30 enables the operator to intuitively understand the placement of the object images to be printed by the printer 10.

Herein, although the application concerned is described with reference to the abovementioned embodiment for a complete and clear disclosure, the appended claims are not to be thus limited but are to be construed as embodying all modifications and alternative constructions that may occur to one skilled in the art that fairly fall within the basic teaching herein set forth. Moreover, the constituent elements explained above can be appropriately combined. Furthermore, the constituent elements can be deleted, substituted, or modified without departing from the scope of the embodiment described above.

The computer program executed in each device according to the embodiment and the modification examples is stored in advance in a memory medium (a ROM or a memory unit (memory)) included in that device. However, that is not the only possible case. Alternatively, the computer program may be recorded as an installable file or an executable file in a computer-readable recording medium such as a compact disk read only memory (CD-ROM), a flexible disk (FD), a compact disk recordable (CD-R), or a digital versatile disk (DVD). The memory medium is not limited to a medium independent from a computer or an embedded system, and also implies a memory medium in which a computer program transmitted via a LAN or the Internet is downloaded and stored or temporarily stored.

Still alternatively, the computer program executed in each device according to the embodiment and the modification examples may be stored in a computer connected to a network such as the Internet and provided by downloading, or may be distributed via a network such as the Internet.

Any of the above-described apparatus, devices or units can be implemented as a hardware apparatus, such as a special-purpose circuit or device, or as a hardware/software combination, such as a processor executing a software program.

Each of the functions of the described embodiments, and any one of the above-described and other methods may be implemented by one or more processing circuits or circuitry. Processing circuitry includes a programmed processor, as a processor includes circuitry. A processing circuit includes devices such as an application specific integrated circuit (ASIC), digital signal processor (DSP), field programmable gate array (FPGA) and conventional circuit components arranged to perform the recited functions.

As used herein, the singular forms “a”, “an” and “the” are intended to include the plural forms as well, unless the context clearly indicates otherwise.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a read requester configured to cause a sensor to read a paper on which one or more marks are drawn;
a detector configured to detect each of the marks from a scan image read by the sensor;
a generator configured to generate a print image in which an object image corresponding to each of the marks, which are detected by the detector, is placed at a position of the respective mark;
an adjustor configured to adjust placement of the object images included in the print image; and
a print requester configured to cause a printer to print the print image.

2. The information processing device according to claim 1, wherein the detector is configured to identify types of the object images according to shapes of the marks.

3. The information processing device according to claim 1, wherein, according to a size of an image region drawn in the scan image, the detector is configured to display a re-stamping image for notifying to press a stamp again.

4. The information processing device according to claim 1, further comprising a notifier configured to display, on a display, a notification image for notifying about overlapping of the object images in a case where a plurality of the object images overlap at least partially.

5. The information processing device according to claim 1, wherein the detector is configured to detect the marks drawn in a predetermined color.

6. The information processing device according to claim 1, wherein the read requester is configured to cause the sensor installed in the printer to read the paper.

7. The information processing device according to claim 6, wherein
the printer comprises:
a paper holder in which the paper on which the marks are drawn is installed;
a roller configured to feed the paper held by the paper holder;
a discharge port through which the paper fed by the roller is discharged; and
the sensor configured to read the paper discharged from the discharge port, and
the read requester is configured to cause the sensor installed in the printer to read the paper.

8. The information processing device according to claim 1, wherein the adjustor is configured to receive, in an editing image for editing the object image, adjustment about placement of the object images.

9. The information processing device according to claim 8, wherein the adjustor is configured to receive, in the editing image, selection of types of the object images corresponding to the marks.

10. The information processing device according to claim 9, wherein, in the editing image, the adjustor is configured to receive selection of types of the object images corresponding to the marks, and orientations of the object images.

11. The information processing device according to claim 8, wherein the adjustor is configured to receive, in the editing image, an edit for content indicated by the object images.

12. The information processing device according to claim 8, wherein the adjustor is configured to receive, in the editing image comprising setting for each of the object images and the object images corresponding to the setting, an edit for placement of the object images.

13. The information processing device according to claim 3, wherein the detector is configured to display the re-stamping image for the image regions having sizes that do not conform from among the image regions having an area greater than or equal to a first threshold value.

14. The information processing device according to claim 3, wherein the detector is configured to display the re-stamping image in a case where lengths of the image regions in specified directions are not equal to specified values set for each of the directions.

15. The information processing device according to claim 2, wherein the generator is configured to identify types of the object images corresponding to the marks according to areas of the marks and lengths of the marks in specified directions.

16. The information processing device according to claim 1, further comprising a memory controller configured to store, in a memory, a print command corresponding to the print image.

17. The information processing device according to claim 16, wherein, in a case where the print command corresponding to the print image having identical or similar placement of the marks detected by the detector is stored in the memory, the generator is configured to obtain the print image obtained by converting the print command stored in the memory.

18. The information processing device according to claim 1, further comprising a printing condition setter configured to receive setting of a printing condition, wherein
the print requester is configured to request printing of the print image according to the printing condition.

19. A print method comprising:
causing a sensor to read a paper on which one or more marks are drawn;
detecting each of the marks from a scan image read by the sensor;
generating a print image in which an object image corresponding to each of the detected marks is placed at a position of the respective mark;
adjusting placement of the object images included in the print image; and
causing a printer to print the print image.

20. A non-transitory computer-readable medium including programmed instructions that cause a computer to function as:
a read requester configured to cause a sensor to read a paper on which one or more marks are drawn;
a detector configured to detect each of the marks from a scan image read by the sensor;
a generator configured to generate a print image in which an object image corresponding to each of the marks, which are detected by the detector, is placed at a position of the respective mark;
an adjustor configured to adjust placement of the object images included in the print image; and
a print requester configured to cause a printer to print the print image.
